(19) United States
(12) Patent Application Publication
(10) Pub. No.: US 2003/0154236 A1
(43) Pub. Date: Aug. 14, 2003

(54) Database Switch enabling a database area network

(76) Inventors: Shaul Dar, Tel Aviv (IL); Roni Gutherz, Tamir (IL); Gil Hecht, Cambridge, MA (US); Boaz Ripin, Beit Yehushua (IL)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/055,443

(22) Filed: Jan. 22, 2002

(51) Int. Cl. G06F 15/16

(52) U.S. Cl. 709/201

(57) ABSTRACT

A method and system for improving utilization of the typical DBMS client-server configuration is provided. Specifically, the present invention can include a Database Switch (dBSwitch) situated between the applications and database servers in a network, capable of dynamically and transparently connecting applications to databases using standard database servers and standard protocols. The Database Switch appliance performs this database routing in real time, with high bandwidth and negligible latency. The Database Switch enables the formation of a Database Area Network (DAN) architecture, which promotes database virtualization by integrating the database servers, the shared storage, and the interconnecting network, making them appear to be one large, scalable database server. This DAN architecture yields high utilization, high availability, scalability on demand, simplified management and security, in a shared and heterogeneous application environment.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD AND BACKGROUND OF THE INVENTION

1. Field of the Invention

The present invention relates, in general, to database configurations in data networks. More specifically, the present invention relates to the fields of intelligent switching between databases in a computer system and database virtualization.

2. Description of the Related Art

Databases are generally defined as collections of data arranged for ease and speed of search and retrieval. Databases generally comprise sets of related files that are created and managed by a database management system (DBMS). DBMS can manage any form of data including text, images, sound and video. The data and file structures are typically determined by the DBMS software. Typical database configurations connect applications to dedicated database servers. Such dedicated configurations usually result in underutilized resources, limited scalability, high cost, and complex management.

Other database configurations can connect many applications to shared database servers. One of the disadvantages of these shared configurations is that they typically compromise performance, quality of service (QoS) and security. Thus, for example, a database instance serving one application can impede another database instance serving another application that is running on the same database server, either inadvertently or on purpose. Another disadvantage of these shared configurations is that one database application or a database administrator can access or even modify the contents of another database.

In a typical database configuration, as shown in FIG. 1, a number of clients (such as application servers, end users workstations, etc.) may access a number of database servers via some network switching equipment, such as one or more layer 2 switches. A layer 2 switch is a network device that forwards traffic based on information available at the data link layer (Layer 2 of the OSI reference model) such as the MAC layer address in Ethernet or Token Ring networks.

However, in a TCP/IP network, each computer is identified by a unique 32-bit IP network layer address, written as a set of four numbers separated by periods, e.g. 192.100.10.1. Various system mechanisms are available to computers on the network to translate between network layer addresses and data link layer address, such as MAC addresses. A process running on one computer can connect to another process on a different computer by specifying the IP address of the remote computer and a port number uniquely identifying the remote process (i.e. the port that the remote process is listening to).

The database clients can connect to the database servers using a proprietary database networking protocol, such as Oracle's SQL*NET, which from a networking standpoint is an application level (layers 5-7) protocol on top of TCP/IP (or other networking protocols). Typically, application programs refer to the database service to which they wish to connect by a symbolic (or logical) name, such as “SALES”. This symbolic name must be translated (bound) to a physical location, namely an IP address and port. This translation can be specified in some configuration file (e.g. tnsnames.ora in Oracle) or in a set of registry entries (in Microsoft's SQL server).

In the DBMS, there is a set of processes that handle application connection requests to a particular database, referred to as the database instance. Depending on the DBMS vendor and version, there can be one or more instances per installation on each database computer. Typically, however, in many DBMS there can be only one instance for each database on all of the database servers at any given time. In most databases, such as Microsoft SQL Server and IBM DB2, the client connects directly to the database instance, using a method referred to as a “direct connection”. However in the Oracle DBMS, the client connects instead to a special process called a “listener”, which then returns to the client the location of the database instance it should connect to (normally a different port on the same machine). This method is hereinafter referred to as an “indirect connection”.

The actual data managed by a DBMS, typically resides on some storage medium accessible to the DBMS computer. In the simple case this may be a local disk, also known as Direct Attached Storage (DAS). According to this method, disk drives are contained within the computer cabinet, and connected to the CPU via PCI or some other local peripheral bus.

In a more advanced storage configuration, the data resides on a storage medium accessible by a plurality of DBMS computers via a network or other high speed communications medium, as can also be seen in FIG. 1. One simple form of shared storage is a shared or multi-host disk. More recently however, there is increasing use of networked storage, comprising specialized storage devices connected to the network. Networked storage, offers important advantages over direct attached storage, including potential sharing of data, centralized management (backup in particular), high degree of redundancy and offloading of storage functions from the servers. For these reasons, networked storage, and Storage Area Network (SAN) in particular, is becoming the de-facto standard DBMS storage system in large data centers. Two of the most common types of networked storage are described below.

Network Attached Storage (“NAS”) typically includes a specialized and dedicated file server that connects to the local area network. A NAS device, as can be seen in FIG. 2, typically contains multiple disks or RAID (Redundant Array of Independent Disks) devices. It runs a slimmed-down (micro-kernel) operating system and file system, and processes only I/O requests by supporting popular file sharing protocols such as NFS (UNIX) and CIFS (Windows). Using traditional LAN protocols such as Ethernet, the NAS enables additional storage to be quickly added by plugging it into a network hub or switch. As network transmission rates have increased from Ethernet to Fast Ethernet to Gigabit Ethernet, NAS devices have come up to speed parity with direct attached storage devices.

Storage Area Network (SAN) typically includes a back-end network connecting storage devices via peripheral communications technology such as SCSI and Fiber Channel. A SAN, as can be seen in FIG. 3, ties multiple hosts into a single storage system, which typically contains many disks or RAID (Redundant Array of Independent Disks) devices, tapes, large amounts of cache and redundant power supplies. The SAN architecture enables what is known as storage virtualization, which refers to the transparent usage of shared storage facilities in a network.

Other database networking technologies include Parallel Architectures and Failover Configurations.

Parallel Architectures are typically, high-end systems, based on parallel database designs, in which there can be many database instances on the different servers (nodes) accessing the same database. These instances work in tight coordination, utilizing inter-node communication supported, for example, by clustering technologies. These systems are designed to provide good performance for a single, large application that cannot run adequately on a single server. Examples of this type of system include: Oracle's OPS and RACS, Microsoft SQL Server Federated Databases, and IBM DB2 EEE.

Failover Configurations typically utilize redundancy to ensure application high availability, i.e. the ability of a critical application to continue working even if the database server it was connected to has failed. Typically each “primary” database sever is associated with a “backup” server and a replication mechanism is used to keep the backup synchronized with the primary server, though some time lag is unavoidable. Usually, the backup server is passive, i.e. it cannot serve other applications while it is tracking the primary server, although in certain cases the backup can serve applications that tolerate slightly old data. If the primary database fails, then some underlying software, such as the clustering layer or the database networking layer, can switch the connections of applications from the primary server to the backup server. Examples of such configurations include Veritas Cluster FailOver, Quest's SharePlex, Oracle's Standby database and Transparent Application Failover (TAF).

U.S. Pat. No. 6,199,069, which is fully incorporated herein by reference for all purposes as if fully set forth herein, describes a system and method for switching between databases without disruption to applications. The “database switcher” according to the '069 patent is a program provided with the application server. The switcher's purpose is to provide a high availability solution, allowing applications to switch from primary to backup database in case of failure. The '069 patent, however, specifically provides improved high availability for a large batch application such as a SAP AG system connected to a DB2 database, and requires a modification to the application server's software to enable the switch to operate in the system. It does not provide for virtualization and sharing of database resources for high utilization as well as high availability. Furthermore the '069 patent necessitates application changes to integrate the application with the switcher code.

U.S. Pat. No. 6,292,800, which is fully incorporated herein by reference for all purposes as if fully set forth herein, describes a database access method that includes receiving a data request at a switcher system from another computer, selecting a connection to a database system from among a collection of connections, and communicating with the database system across the selected connection to fulfill the data request. The '800 patent provides for the sending of requests in a specialized proprietary declarative format to the switcher system. These requests are converted into SQL queries, and routed to the database that matches the queries. The switcher queues queries, and correlates database responses to queries based on request “ID” and “correlation ID” values. The '800 patent, however, does not use standard database protocols, and it requires application changes to use the specialized protocol. Because the switcher is asynchronous it is mostly suited for high latency queries, such as those sent from a remote client over the Internet. The term latency refers to the delay associated with processing a database networking message. In addition, the switcher software is state-full, i.e. it must maintain and update the information required to perform the abovementioned correlation of queries and responses. If the switcher crashes, clients can no longer communicate with servers. The switcher is also sensitive to the physical placement of DBMS data. Changes to the data will necessitate replication and/or repartitioning, which in turn may require switcher reconfiguration, during which its functionality is hampered.

Accordingly, there is a need for a system that can utilize existing database resources and protocols, to provide virtualization of a group of database servers, by dynamically and transparently connecting applications to databases with high bandwidth and negligible latency. Such a system should furthermore provide for high utilization, high availability, scalability on demand, simplified management and security, in a shared and heterogeneous application environment.

### SUMMARY OF THE INVENTION

According to the present invention there is provided a method and system for improving DBMSs and associated databases.

More specifically, there is provided an architecture for database virtualization, that enables usage of existing database resources and protocols, providing high utilization, high availability, scalability on demand, simplified management and improving security, in a shared and heterogeneous application environment. This new architecture, (hereinafter referred to as Database Area Network or DAN), includes a switching system that connects applications to a pool of database servers. The system can be embodied in a device, hereinafter referred to as Database Switch or “dBSwitch,” connected to the Database Area Network or can be embodied in software that is executed at one or more of the computers connected to the Database Area Network. This architecture provides database virtualization, which refers to separating the applications from the infrastructure, such that a plurality of applications can interact with a plurality of databases on the DAN, in a transparent way, using dynamic switching to match application requests to DBMS data sources. Such dynamic switching entails intelligently constructing a mapping of database instances to database servers and using a network switching device that can perform the switching decisions in real time.

The DAN, according to the present invention, comprises a Shared or Network Storage system, for storing DBMS data, at least one Database Server having a database management system and a switching system, such as a dB Switch, adapted for providing intelligent routing and/or switching functionality. A database client, such as an Application Server or an end user computer, can submit database requests on behalf of at least one application to a DBMS on the DAN.

In accordance with the invention, the DAN enhances the capabilities and simplifies the management of a group of database servers in a shared and heterogeneous application environment. The DAN enables application requests to be are allocated to database servers dynamically, yielding high utilization, high availability, scalability on demand and improved security. In addition, because the DAN enables virtualization of database services and centralization of management functions, it also allows for simplified management of the DBMSs and associated databases.

### BRIEF DESCRIPTION OF THE DRAWINGS

The invention is herein described, by way of example only, with reference to the accompanying drawings, wherein:

FIG. 1 is an illustration of a typical prior art database configuration

FIG. 2 is an illustration of a NAS topology.

FIG. 3 is an illustration of a SAN topology.

FIG. 4 is a diagrammatic view of a DAN system according to the present invention, wherein the dBSwitch is between the data link layer switch and the database servers.

FIG. 5 is a diagrammatic view of a DAN system according to the present invention, wherein the dBSwitch is on the side of the data link layer switch.

FIG. 6 is a diagrammatic view of the dBSwitch components in accordance with one embodiment of the invention.

FIG. 7 is a diagrammatic view of Packet Routing Alternatives in accordance with the invention.

FIG. 8 is a diagrammatic view of the Database Area Network Abstraction in accordance with the invention.

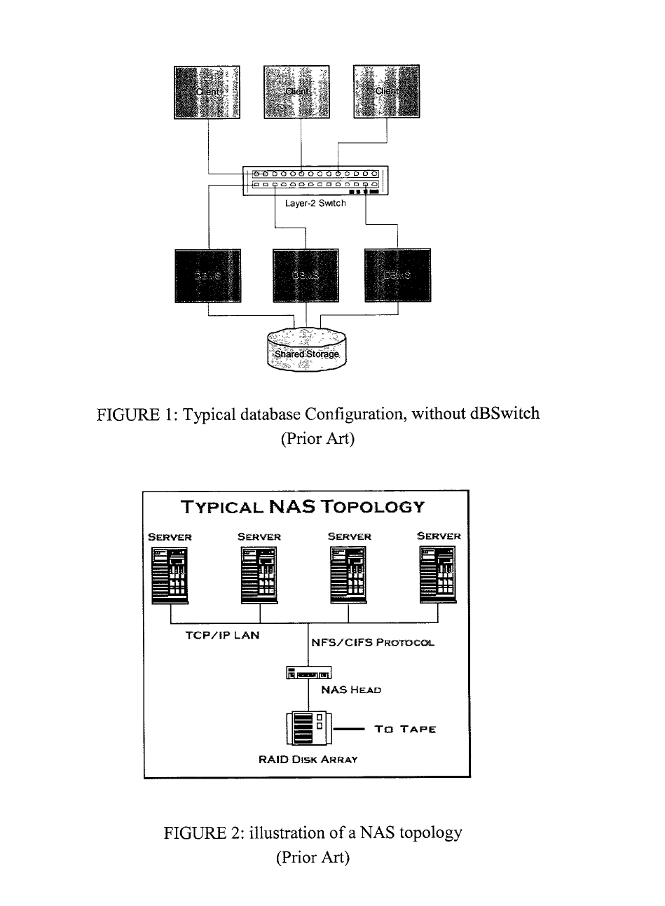

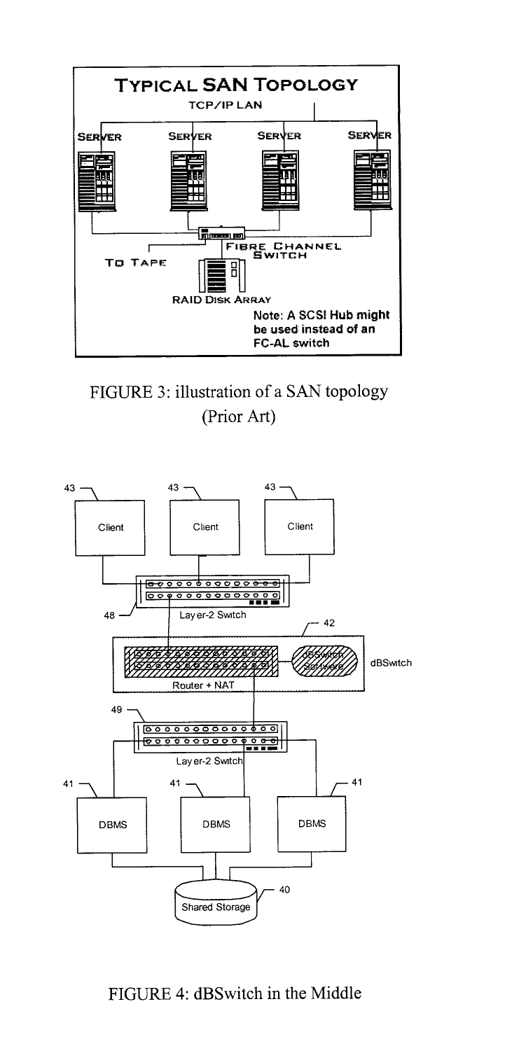

### DESCRIPTION OF THE PREFERRED EMBODIMENT

According to the present invention there is provided a method and system for improving a DBMS configuration. The present invention provides an architecture for database virtualization, that can use existing database resources and protocols to simplify the management of a group of database servers, provide high utilization of system resources, provide high availability of data to applications, provide scalability on demand and provide security, in a shared and heterogeneous application environment.

The following illustrative description is presented to enable one of ordinary skill in the art to make and use the invention as provided in the context of a particular application and its requirements. Various modifications to the preferred embodiment will be apparent to those with skill in the art, and the general principles defined herein may be applied to other embodiments Therefore, the present invention is not intended to be limited to the particular embodiments shown and described, but is to be accorded the widest scope consistent with the principles and novel features herein disclosed.

Specifically, the present invention is directed to a database switching system or device, herein referred to as “dBSwitch,” adapted to be connected between the applications and database servers in a network, enabling the formation of a Database Area Network (DAN) architecture. In one embodiment, the dB Switch is embodied in the form of a network appliance herein referred to as a Database Switch Appliance. The DAN architecture can provide database virtualization, in which requests are processed by one or more system elements without requiring knowledge of the inner makeup or operations of the system. The system combines the elements into a single functional unit, which operates transparently to the user. The DAN can provide database virtualization by integrating the database servers, the shared storage, and the interconnecting network, and making them appear to be one large, scalable database server.

The present invention can make database networking protocol-switching decisions in real time. For example, when an application wishes to connect to a database instance, it sends a request to a database server which is received by the dBSwitch. The dBSwitch dynamically connects the application to a database server that serves the requested instance. When the need arises, such as the case where that database server fails, becomes loaded, or needs to be taken down for upgrade, the switch can dynamically redirect the application to a different server (transparent to the client and the application) in real time.

The principles and operation of a system and a method according to the present invention may be better understood with reference to the drawings and the accompanying description, it being understood that these drawings are given for illustrative purposes only and are not meant to be limiting, wherein:

FIG. 4 shows a system according to the present invention. The system can include Shared Storage 40 (for storing DBMS data that can be accessed by all database servers 41), one or more database servers 41, a dBSwitch 42, and one or more clients 43. Each Database Server 41, can be adapted to provide database management services such as through the use of DBMS software. The DBMS software can serve to facilitate the organization, storage, retrieval, security and integrity of data in the shared storage 40, including accepting requests from applications and instructing the operating system to transfer the appropriate data. The dBSwitch 42 can be connected between two data link layer (layer 2) switches, where one layer 2 switch 48 is connected (directly or through additional switches) to the database servers, and the other layer 2 switch 49 is connected (directly or through additional switches) to the clients. The dBSwitch 42 can provide for intelligent routing of data requests to the appropriate database server 41. Each of the clients 43 can be any device adapted for submitting requests on behalf of at least one application, for example a personal computer or an Application Server.

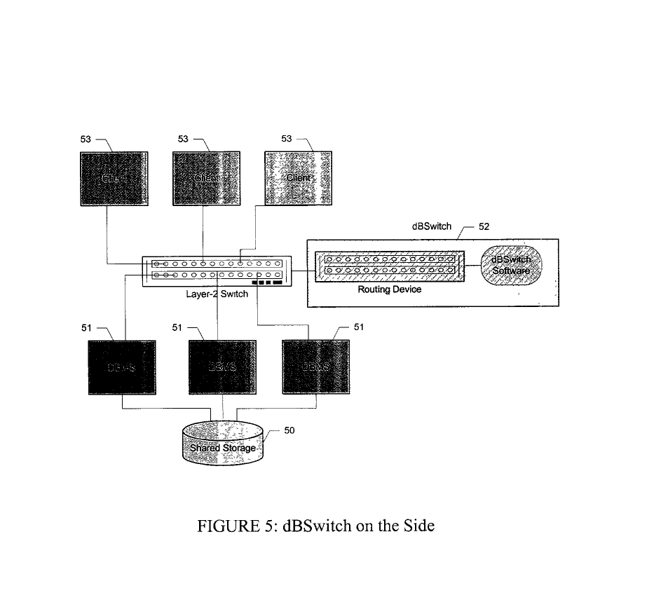

FIG. 5 shows a system according to an alternate embodiment of the present invention. Similar to FIG. 4, the system can include Shared Storage 50 (for storing DBMS data that can be access by all database servers 51), one or more database servers 51, a dBSwitch 52, one or more clients 53 and a layer 2 switch 59 connected (directly or through additional switches) to the database servers 51 and clients 53. Each Database Server 51, can be adapted to provide database management services such as through the use of DBMS software. The DBMS software can serve to facilitate the organization, storage, retrieval, security and integrity of data in the shared storage 50, including accepting requests from applications and instructing the operating system to transfer the appropriate data. The dBSwitch 52 can be connected to the Layer 2 switch and provide for intelligent routing of data requests to the appropriate database server 51. Each of the clients 53 can be any device adapted for submitting requests on behalf of at least one application, for example a personal computer or an Application Server.

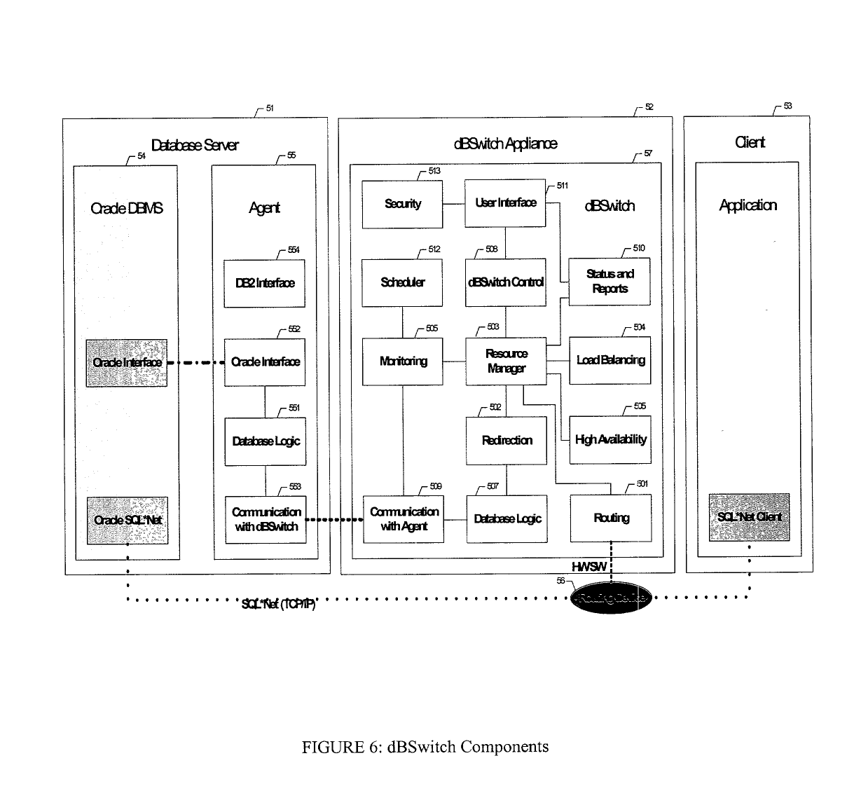

FIG. 6 shows a set of software modules that can be used in the implementation of the present invention. The Database Server 51 can include two components: a DBMS 54 and one or more Agent Modules 55. The DBMS 54 can be adapted to manage data in multiple databases, and to serve data in response to client (application) requests. The Database Server 51 can include various agent modules 551-554 which are adapted to provide communication of data and commands between the DBMS 54 and the dBSwitch appliance 52.

The Agent Modules 55 can, for example, include a Database Logic Module 551, one or more specific Database Interface Modules, such as Oracle Interface Module 552, and DB2 Interface Module 553, and a Module for communication with the dBSwitch, such as Communication Module 553. The Database Logic 551 can be adapted to implement DBMS related logic by invoking DBMS specific modules, for example, for stopping or starting an instance. The Oracle Interface 552 can be adapted to implement Oracle specific logic by calling Oracle executables, for example through the use of a scripting language such as TCL. The Module for Communication with dBSwitch 553 can be adapted to enable agent communication with the dBSwitch, for example, by mirroring the “dBSwitch Communication with Agent” module. The DB2 interface 554 is provided to illustrate the presence of non-Oracle support in the DAN, according to the present invention. For each additional DBMS vendor, a vendor-specific DBMS module can be provided, such as the DB2 interface 554.

As shown in FIG. 6, the dBSwitch 52 in accordance with the present invention can include a routing device 56, controlled by dBSwitch software running on a separate device 57, and a plurality of software modules. In one embodiment, the routing device can be a standard network router, while in an alternative embodiment, the routing device can be a Network Address Translation (NAT) router. In a still further embodiment, the routing device can be a content routing switch.

Preferably, the routing device is a switch operating at the network layer (layer 3), also known as “routing switch” or “switch router,” capable of making network layer routing decisions based on a routing table and supporting standard routing protocols at high speed. Preferably, the NAT router can be used for mapping IP addresses from one domain or subnetwork to another, in an attempt to provide transparent routing to hosts and, more specifically, the device can perform static network address translation, such as mapping a set of IP addresses to another set of IP addresses based on an access list specification. In addition, NAT device can be capable of performing NAPT (Network Address Port Translation) as well as full (also known as “twice”) NAT functionality.

According to another embodiment of the present invention, the dBSwitch can include an advanced networking device known as a content switch. A content switch is a higher layer (e.g. layers 5-7) switch capable of peering inside TCP/IP messages and inspecting their contents. Some content switches have been deployed for routing HTTP traffic to an appropriate Web server based on the URL of the request; they are also known as “URL switches”, “Web content switches” or “Web switches”. According to the present invention, a content switch can be used for inspecting database networking protocol communication, such as Oracle SQL*NET, and for providing additional dBSwitch features, such as improved security and Quality of Service.

The dBSwitch software can include any of the modules shown in FIG. 6. The modules can include the following: a Routing Module 501, a Redirection Module 501, a Resource Management Module 503, a Load Balancing Module 504, a High Availability Module, 505, a Monitoring Module 506, a Database Logic 507, a dBSwitch Control Module 508, a dBSwitch Communication (with Agent) Module 509, a Status and Reports Module 510, a dBSwitch User Interface 511, a Scheduler Module 512 and a Security Module 513.

The Routing (HW/SW Integration) Module 501 can be adapted to communicate with the dBSwitch router 56 (NAT/Content Switch) to control the data routing functions using well known methods such as a command line interface (CLI) or standard network management protocols such as SNMP, CMIP, MIB and RMON.

The Redirection Module 502 can be adapted to perform redirection of requests from one server to another. This includes modifying the database instance associations and the routing rules in order to support the relocation of the instance from a first server to a second server The Resource Management Module 503 can be adapted to provide resource management functions including the use of various processes for instance assignments to servers, for storing information on server resources and instance requirements in an historical “database”, and for using that information for making decisions on instance assignments.

The Load Balancing Module 504 can be adapted to provide load balancing functions and to facilitate scalability (adding additional database servers) by redistribution of instances, moving some instances to new Database Servers 51. The Load Balancing Module 504 can by a sub-module of the Resource Management Module 503.

The High Availability Module 505 can be adapted to provide for high availability of the Database Servers 51, enabling support for failover (database server fails) or planned database server maintenance by redistribution of instances, by moving instances from failed servers or servers that need to be take offline to other servers. The High Availability Module 505 can by a sub-module of the Resource Management Module 503.

The Monitoring Module 506 can be adapted support monitoring functions, such as the monitoring of the DBMS servers resources and instances: e.g. availability and consumption of resources such as CPU usage and memory.

The Database Logic Module 507 can be adapted to enable DBMS related functions such as, stopping or starting an instance.

The dBSwitch Control Module 508 can be adapted to facilitate control of the dBSwitch and DAN. For example to allow adding another server to the DAN.

The dBSwitch Communication (with Agent) Module 509 can be adapted to enable communication between the dBSwitch 52 and the agents 55 on the Database Server 51. Preferably, this module can be implemented using an RPC (Remote Procedure Call) mechanism and can hide all communication and cross-platform details from other modules.

The Status and Reports Module 510 can be adapted to provide external and internal status and operation reports. Preferably, this module can utilize both current and historical information, and can perform formatting (e.g. to HTML) and other data manipulation as may be required.

The dBSwitch User Interface Module 511 can provide an interface for administrators to monitor and control the dBSwitch. It can include methods for communicating with the dBSwitch control module 508 and the status and reporting modules 510.

The Scheduler Module 512 can be adapted to provide scheduling functionality, for example to allow for scheduling actions at specific time points and for recurring actions (e.g. monitor servers every 5 minutes).

The Security Module 512 can be adapted to provide support for DAN security mechanisms including access control, utilizing information about entities such as databases, applications, administrators, and the relationships between them.

The Process:

According to one embodiment of the present invention, the dBSwitch can use a router 56 to dynamically direct database requests from clients to servers. The dBSwitch can use software agents 55 on the database servers to probe their status and to perform operations, such as redirecting a database instance from one server to another.

These software agents 55 can have at least two roles: 1) Relaying dBSwitch commands to the DBMS. The important commands are those used for instance redirection, for example, “stop instance” (on a machine where an instance is moved from) and then “start instance” (on a machine where an instance is moved to); and 2) Monitoring the DBMS and underlying computer system (e.g. for availability, resource consumption) on a routine basis and/or when instructed by the dBSwitch, and pass the information to the dBSwitch.

Communication between the agents and dBSwitch may be encrypted, in order to ensure that the agents only performs commands on behalf of the dBSwitch and that information sent from the agents can only be used by the dBSwitch.

In accordance with invention, the Database Servers 41, 51 and clients (application servers) 43, 53 can be physically connected to different ports on the dBSwitch 42, 52. Alternatively, the Database Servers 41, 51 and the clients (application servers) 43, 53 can be physically connected to different ports on one or more Layer 2 switches which can be directly connected to the dBSwitch 42, 52. In this embodiment, the dBSwitch 42, 52 can control the Layer 2 switches to perform routing functions.

When an application wishes to connect to a database, it sends a request which is received by the dBSwitch 52. The dBSwitch 52 is aware of which database server (or servers) currently serves a particular database and it connects the application to the desired database. This routing can be performed by hardware in real time by using a routing device 56 capable of performing a very large number of routing operations at or near wire speed. The dBSwitch software can dynamically modify the allocation of database instances to database servers in order to match current database servers characteristics (e.g. availability and load of resources such as CPU and memory) with application's needs and desired quality of service (QoS).

If a Database Server 51 fails, the switch can dynamically redirect each application connected to that server to a different database server and this redirection procedure can be transparent to the application, as far as the connection is concerned. The redirection procedure is known in the art.

If the Database Server 51 is brought down, the switch can dynamically redirect each application connected to that server to a different database server and this redirection procedure can be transparent to the application, as far as the connection is concerned.

If the Database Server 51 becomes overloaded, some instances can be redirected from it to other servers, so that the load can be more evenly distributed between the servers. The choice of applications to redirect can take into account the Database Server's characteristics, the application's needs and their quality of service requirements.

In general, the dBSwitch resource manager 503 can manage the assignment (mapping) of instances to servers. The initial mapping can be the state that existed before the dBSwitch. Following the initial mapping, the dBSwitch can change assignments dynamically (perform instance redirections), based on network and database server factors, in order to satisfy utilization, availability and scalability goals. The present invention therefore enables dynamic database switching, according to chosen criteria.

When an instance is moved from one database server to another, the redirection of requests from a client to that database instance, i.e. the point at which the requests are sent to the second database server instead of the first database server, can in principle be chosen at different granularities, such as redirection of a session or connection, a query or a transaction. In the following we describe redirection assuming it is done at the level of a session.

The algorithms necessary to implement the various possible scenarios depend on the determination of the objectives and priorities determined by the administrator, designer or user of the database architecture. For example, the database administrator may determine the need to configure the dBSwitch to implement: 1) Load balancing—to have similar loads on all servers; 2) Scalability—when a new server is added, to distribute the load to provide more uniform availability or to meet other requirements; 3) High Availability—when a server fails or needs to be taken down, remove instances from it and distribute them to other servers.

The user may specify constraints on instance assignments, for example to specify that an instance not be moved in a certain time period (e.g. 8 AM-4 PM daily). Another type of constrains may group instances together, specifying that they should be moved as a group (e.g. because they contain cross references, such as linked database tables or integrity constraints). Additionally the user may specify preferences related to instance assignments, such as specifying how often instances may be redirected. At one extreme the user may require that some instances not be redirected at all, except in response to failure, in order to achieve maximal high availability. At the opposite extreme the user may require that other instances may be redirected freely, in order to achieve maximal load balancing. Additionally the user may assign each instance a rank indicating its importance, expressing a preference that low-ranking instances be moved in preference to high-ranking instances. The resource manager algorithms also take into account the abovementioned constrains and preferences.

The resource manager may use historical information on instance resource requirements and server loads in order to establish patterns and perform predictions. For example it may note that a certain instance exhibits a surge of resource consumption on each evening between 7-9 PM, and use that pattern to influence instance redirection decisions.

The high availability features, according to the present invention, do not rely on pre-designation (“hard wiring”) of a backup server. Pre-designation is clearly not an optimal configuration in terms of load balancing or high availability itself (if the backup fails, you're in trouble). The present invention enables dynamic high availability, where the backup can be selected when it is needed. Each server can run multiple instances that can be redirected, hence algorithms are required for selecting new servers for these instances.

The present invention enables high availability by providing for integration of such algorithms, that, for example: 1) Solve the optimal redirection equations for all instances at once; 2) Make the redirection decision one instance at a time (i.e. decide where to move the first instance I₁, say to server S₁; update predicted load on S₁ based on I₁'s characteristics; and then make the decision for instance I₂ etc.); and 3) Make the redirection decision one instance at a time, but first rank instances by decreasing the order of some dimension (simple or compound), and then working down from “fattest” instance to the “leanest”.

The actual algorithms that may be used to achieve such high availability can be prepared by routine development by someone skilled in the art, according to the chosen criteria.

In accordance with the present invention, the method of switching can include the following steps:

1) Connecting the dBSwitch to the physical network and the actual wiring that lets the dBSwitch exchange data with the database clients and servers.

2) Assigning the IP addresses to the database servers and associating the IP addresses with database service requests from database clients.

3) Routing database networking protocol packets from the database clients 43, 53 to the database servers 41, 51 as a function of the the IP address assignments and/or associations.

4) Routing non-database packets from the database clients 43, 53 to the database servers 41, 51.

In one embodiment of the present invention, the dBSwitch can be inserted between the Layer 2 switch and the database servers, as can be shown in FIG. 4 and all communication from the clients to the database servers (database or non-database) can flow through the dBSwitch router.

In an alternative embodiment of the present invention, the dBSwitch can be connected to the Layer 2 switch, via one or more ports, as can be shown in FIG. 5. Communication between clients and servers can go through the dBSwitch router. Additional techniques can be utilized to facilitate this embodiment, such as virtual IP addresses or separate subnets. Some of these techniques can be used to direct only the database networking packets to go through the dBSwitch, while others can affect all communications.

Various addressing schemes can be used to facilitate the dBSwitch functions. In one embodiment of the invention, the database servers keep their original IP addresses (the IP addresses are unchanged) and the dBSwitch is in charge of performing network address translation (NAT), replacing the destination of each request from a virtual IP address to a physical database server IP address. Each instance (process or set of processes) listens for incoming requests on a unique port.

In an alternative embodiment, herein referred to as Loopback Alias addressing, each database server is assigned a set of virtual IP addresses, one per service. Each database instance listens for requests on the IP address associated with that service. All the instances may use the same port number or different port numbers.

In another alternative embodiment, separate subnet addressing can be used wherein the database servers can be placed in a separate subnet from the clients, with the dB Switch performing address translation (NAT) between the two subnets. A TCP/IP network can be divided into 2 or more subnets, in which case these subnets differ in some initial portion of their IP addresses. Assume for example that in the pre-dBSwitch configuration all machines were in subnet 192.*.*.*. After adding the dBSwitch we reassign the database servers to a new subnet 172.*.*.*, and assign to the dBSwitch router the responsibility of routing and address translation (NAT) between the two subnets (e.g. by appropriate configuration of the default gateway). As a result, all communication between clients and database servers (both ways) will go through the dBSwitch router.

In another alternative embodiment of the invention, herein referred to as Virtual Database Service IP addressing, Virtual Database Service IP addresses can be assigned whereby each database instance (service) can be associated with a unique (virtual) IP at a fixed port (e.g. 5000). The virtual service IP addresses can be taken from a new subnet, in which case the dBSwitch router can be configured to control the routing between the two subnets. In addition, the clients' database configuration (e.g. the TNSNAMES file in the case of Oracle) can be modified so that connections to the database severs are directed to the virtual IP address associated with the desired service (e.g. 172.0.0.101 for instance 1, 172.0.0.102 for instance 2 and so on) at the fixed port number.

In another alternative embodiment of the invention, herein referred to as Virtual DAN IP addressing, Virtual DAN IP addresses can be assigned whereby the dBSwitch router, representing the DAN can be assigned an IP address, such as 192.0.0.100 and each database instance (service) can be associated with a unique port. In addition, the clients' database configuration (e.g. the TNSNAMES file in the case of Oracle) can be modified so that connections to the database severs are directed to the dBSwitch router (i.e. to IP 192.0.0.100) at the port associated with the desired service.

In the embodiment where the dBSwitch is only connected to the Layer 2 switch, the addressing scheme that provides “separate subnets” will essentially forces all communication through the dBSwitch. In contrast, addressing schemes that provide for Virtual DAN IP addressing and Virtual Database service IP addressing will force only the database messages through the dBSwitch.

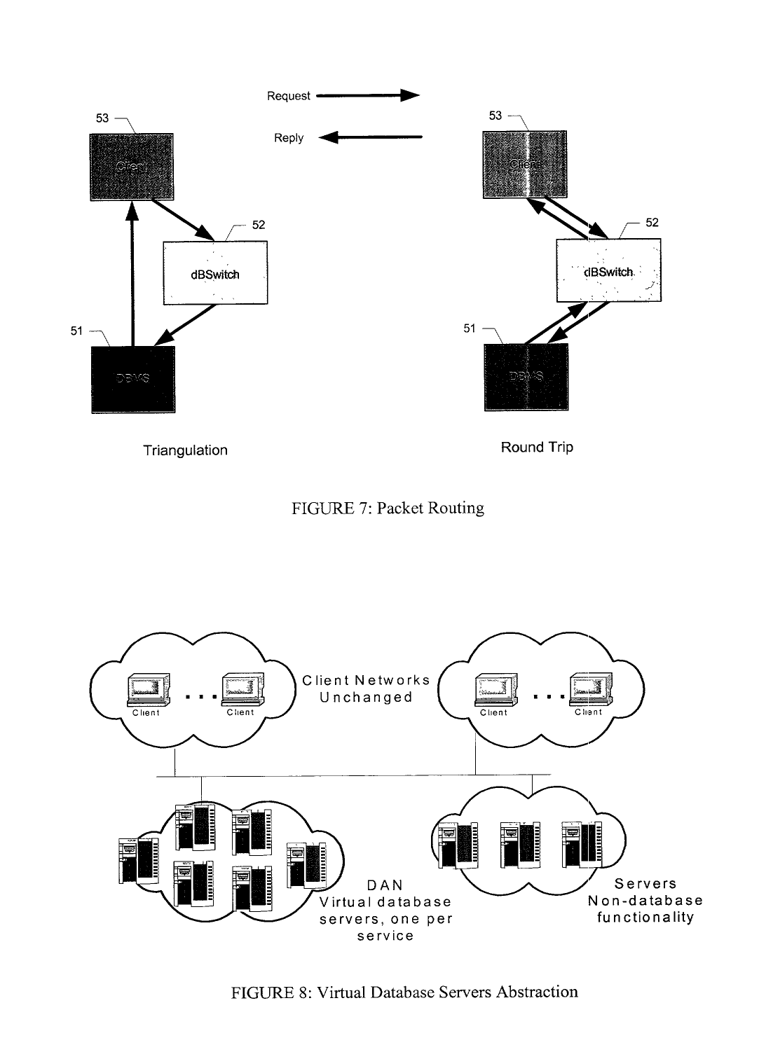

As shown in FIG. 7, Routing of database packets in accordance with the invention can occur in two ways, 1) Direct Server Return—where packets from the clients to the servers go through the dBSwitch, but return packets go directly from the servers to the clients and 2) Round Trip—where packets traveling in both directions are routed through the dBSwitch.

Additionally, depending on the DBMS vendor, this routing may be applied to a direct or indirect connection. When indirect connection is used the above routing may be applied to the initial connection establishment packets as well as to subsequent data packets. When direct connection is used the above routing is applied uniformly to all the packets.

In one embodiment of the routing function in accordance with the present invention, Virtual Database Service IP addressing is combined with multiple server IP addresses (loopback alias addressing), where the database servers are on a separate subnet. In this embodiment, the dBSwitch performs routing only (no NAT), mapping IP (layer 3) addresses to MAC (layer 2) addresses, and thus directing each request to the database server currently serving that virtual IP.

Following are examples of database packets routing with alternative preferred embodiments.

### EXAMPLE 1

In example 1 clients specify virtual database service IP addresses and database servers are configured with multiple IP addresses (loopback alias addressing). Clients and servers are on separate subnets. We are assuming the indirect connection method, used with the Oracle DBMS.

The client resides on subnet 192.168.0.x, trying to reach a DBMS which is on subnet 10.0.0.x. This connection is typically provided through a router, connecting the two subnets.

The virtual IP address for the Database servers are allocated in the range 172.0.0.1 through 172.0.0.16. This information is configured in the client's tnsnames.ora file.

The client sends the open connection packet to the virtual address of the service. The packet will first go to the default gateway router as specified by the client, to resolve the address. The gateway directs the packet to the dBSwitch. If the client and dBSwitch reside on the same network then subsequent queries may be sent directly to the dBSwitch after the default gateway issues an ICMP redirect command to the client.

| | | | Destination | | Source | | |
|---|---|---|---|---|---|---|---|
| | Direction | Type | IP | Port | IP | Port | Comment |
| | Client to | Open | 172.0.0.10 | 6000 | 192.168.0.1 | 8000 | May go through |
| | dBSwitch | session | | | | | default gateway |
| | | query | | | | | |
| 1 | dBSwitch | Open | 172.0.0.10 | 6000 | 192.168.0.1 | 8000 | No change |
| | to Server | session | | | | | |
| | | query | | | | | |
| 2 | Server to | Open | 192.168.0.1 | 8000 | 172.0.0.10 | 6000 | Contains server |
| | Client | session | | | | | VIP |
| | | response | | | | | (172.0.0.10) and |
| | | | | | | | port (7300) |
| 3 | Client to | Data | 172.0.0.10 | 7300 | 192.168.0.1 | 8010 | |
| | dBSwitch | | | | | | |
| 3 | dBSwitch | Data | 172.0.0.10 | 7300 | 192.168.0.1 | 8010 | |
| | to Server | | | | | | |
| 4 | Server to | Data | 192.168.0.1 | 8010 | 172.0.0.10 | 7300 | |
| | Client | | | | | | |

Note that the dBSwitch forwards the packet to the server, although the server does not publicly support the virtual IP address. This is done using the MAC address of the server.

The server is configured with the virtual IP address in a loopback alias addressing configuration. Hence it responds to the packet with the virtual IP and not the actual IP address. The listener shall use the virtual IP address in the content of the response packet when it returns the IP and port number of the database process.

### EXAMPLE 2

Example 2 is similar to example 1, but clients, servers and the dBSwitch on the same subnet. In the detailed list below; we also included the virtual addresses as part of the same subnet, demonstrating the indifference of the process to the actual network configuration.

| | | | Destination | | Source | | |
|---|---|---|---|---|---|---|---|
| | Direction | Type | IP | Port | IP | Port | Comment |
| 1 | Client to | Open | 172.0.0.105 | 6000 | 172.0.0.1 | 8000 | |
| | dBSwitch | session | | | | | |
| | | query | | | | | |
| 1 | dBSwitch | Open | 172.0.0.105 | 6000 | 172.0.0.1 | 8000 | |
| | to Server | session | | | | | |
| | | query | | | | | |
| 2 | Server to | Open | 172.0.0.1 | 8000 | 172.0.0.105 | 6000 | Contains server |
| | client | session | | | | | Virtual IP |
| | | response | | | | | (172.0.0.105) |
| | | | | | | | and port (7300) |
| 3 | Client to | Data | 172.0.0.105 | 7300 | 172.0.0.1 | 8010 | |
| | dBSwitch | | | | | | |
| 3 | dBSwitch | Data | 172.0.0.105 | 7300 | 172.0.0.1 | 8010 | |
| | to Server | | | | | | |
| 4 | Server to | Data | 172.0.0.1 | 8010 | 172.0.0.105 | 7300 | |
| | Client | | | | | | |

### EXAMPLE 3

In example 3 clients specify Virtual Database Service IP addresses but each database server is assigned a single physical IP address. Clients and servers are on separate subnets. The dBSwitch performs routing as well as address translation (NAT), replacing the virtual IP specified in the client request with the physical IP of the database server associated with that service. We are assuming the indirect connection method used with the Oracle DBMS.

Packet Flow is as Follows:

1. Initial Connection—Client to Server

The initial connection request goes from the client to the dBSwitch. The dBSwitch performs 1-way NAT, changing the destination IP and port to the IP of the database server that provides the requested service and the port number of the Oracle listener for that instance. The dBSwitch then sends the packet to the same IP and port.

2. Initial Connection—Server to Client

The listener sends back to the client a packet containing the IP address and port of a process accepting requests for this instance. The packet is routed through the dBSwitch, which is configured as the gateway for the servers for all server-client traffic. The content of the packet, including the specified IP and port numbers, are not modified.

3. Data (Queries): Client to Server

The client sends the query to the database server. The packet goes through the dBSwitch since the dBSwitch is the router for that subnet. No NAT is required.

4. Data (Queries): Server to Client

Server responds to the client through the dBSwitch.

Note that unlike the open session messages, the data messages use the true end-to-end IP addresses and ports of the client and server. The dBSwitch performs as a standard router connecting two separate subnets.

In the example the client resides on subnet 192.0.10.x, trying to reach a DBMS which is on subnet 172.0.0.x. The virtual IP address for the Database servers are allocated in the range 172.0.0.1 through 172.0.0.16. This information is configured in the client's tnsnames.ora file. The client sends the open connection packet to the virtual address of the service. The packet first goes to the default gateway router as specified by the client, to resolve the address. The gateway directs the packet to the dBSwitch. If the client and dBSwitch reside on the same network, then subsequent queries may be sent directly to the dBSwitch after the default gateway issues an ICMP redirect command to the client.

| | | | Destination | | Source | | |
|---|---|---|---|---|---|---|---|
| | Direction | Type | IP | Port | IP | Port | Comment |
| 1 | Client to | Open | 172.0.0.10 | 1521 | 192.0.0.1 | 8000 | May go through |
| | dBSwitch | session | | | | | default gateway |
| | | query | | | | | |
| 1 | dBSwitch | Open | 172.0.0.105 | 4535 | 192.0.0.1 | 8000 | |
| | to Server | session | | | | | |
| | | query | | | | | |
| 2 | Server to | Open | 192.0.0.1 | 8000 | 172.0.0.105 | 4535 | Contains server IP |
| | dBSwitch | session | | | | | (172.0.0.105) and |
| | | response | | | | | port (7300) |
| 2 | dBSwitch | Open | 192.0.10.1 | 8000 | 172.0.0.10 | 1521 | Contains server IP |
| | to Client | session | | | | | (172.0.0.105) and |
| | | response | | | | | port (7300) |
| 3 | Client to | Data | 172.0.0.105 | 7300 | 192.0.0.1 | 8000 | |
| | dBSwitch | | | | | | |
| 3 | dBSwitch | Data | 172.0.0.105 | 7300 | 192.0.0.1 | 8000 | No Change |
| | to Server | | | | | | |
| 4 | Server to | Data | 192.0.0.1 | 8000 | 172.0.0.105 | 7300 | |
| | dBSwitch | | | | | | |
| 4 | dBSwitch | Data | 192.0.0.1 | 8000 | 172.0.0.105 | 7300 | No Change |
| | to Client | | | | | | |

### EXAMPLE 4

Example 4 is similar to example 3, but we are assuming a direct connection method, as is the case with the DB2 and SQL Server DBMS (see background). Hence clients always send database packets to the virtual IP address, and the dBSwitch performs NAT on all traffic.

| | | | Destination | | Source | | |
|---|---|---|---|---|---|---|---|
| | Direction | Type | IP | Port | IP | Port | Comment |
| 1 | Client to | Query | 172.0.0.10 | 1430 | 192.0.0.1 | 8000 | |
| | dBSwitch | | | | | | |
| 1 | dBSwitch | Query | 172.0.0.103 | 4535 | 192.0.0.1 | 8000 | |
| | to Server | | | | | | |
| 2 | Server to | Response | 192.0.0.1 | 8000 | 172.0.0.103 | 4535 | |
| | dBSwitch | | | | | | |
| 2 | dBSwitch | Open | 192.0.0.1 | 8000 | 172.0.0.10 | 1430 | |
| | to Client | session | | | | | |
| | | response | | | | | |

Non-Database Packet Routing

Non-database packets can be routed directly from client to database server and back, or using any of the methods described herein for routing database packets though the dBSwitch, for example, direct server return or round trip routing.

With the Virtual Database Service IP addressing scheme, non-database packets can be directed in two ways, as illustrated in FIG. 7:

1) To an IP addresses of a physical database server. In this case the message is simply be routed through the dBSwitch to that server.

2) To a virtual service addresses. In this case the message is routed through the dBSwitch to the appropriate physical database server currently associated with that database service.

For instance, if a client shall access a Telnet service on a server machine using its physical IP address, the request will go directly to the machine specified by the client. If, however, the client wishes to open a Telnet session in the machine running a specific database instance, it may send a telnet packet to the virtual IP address of the database server. The dBSwitch will redirect this to the actual server running the service. In this way, the dBSwitch may be also configured to allow or block various non-database services directed at the virtual database servers.

Management of the dBSwitch

In a standalone DBMS there is a single management role (which can be assigned to one or more administrative personnel), called the Database Administrator (DBA). However the DAN architecture, according to the present invention, provides virtualization of a pool of database servers, making them appear as one large DBMS. Accordingly, there is a need for a new global administrative role for the DAN. At the same time, the DAN can also allow for autonomous administration of individual database services, independent of the dynamic assignment of these services to physical database servers.

In accordance with the invention, two new and distinct levels of administrative responsibility can be provided.

1) Administration of the DAN. We refer to this role as database area administrator or DAA.

2) Administration of individual database services. We refer to this role as database service administrator or DSA.

In accordance with the invention, a DSA can perform operations related to a specific database or instance, such as schema modifications, monitoring, stopping or starting the instance, scheduling backup etc. But a DSA does not have knowledge of or authority to manage other database services. Furthermore a DSA is unaware of physical characteristics of the DAN (such as number of servers) and of the mapping of individual services (including his own) to database servers.

In accordance with the invention, a DAA can perform operations related to the DAN itself and to any machine or service in the DAN, such as adding or removing servers or modifying global parameters, for example to effect load balancing behavior. In some configurations, the DSA and DAA can be representatives from different organizations. For example, in the hosting market, the DAA can represent the hosting company while each DSA can represent a different enterprise with a hosted application.

Security

The dBSwitch can enable the creation of a secure connection between applications and databases, as well as the secure administration of the entire DAN and of individual databases. Standard database and operating systems security relies on user (and program) authentication via a password mechanism. In addition, networking security mechanisms, such as firewalls, increase security by partitioning the network into multiple zones differing in their level of security (trust), and restricting communication between the zones. However, as discussed below, the DAN architecture creates new security challenges that must be addressed.

In the DAN architecture, every access to a server in the DAN typically has one of the following distinct purposes:

Applicative access: from an application to a database, identified by a virtual IP and a database port, using a database networking protocol.

Administrative access: from an administrator or administrative program to either a database or a server (see details below), for the purpose of executing a specific supported program (such as TELNET or FTP), identified by a unique port, using the application-level networking protocol for that program.

Any access to the DAN that is not applicative or administrative, as defined above, can be disallowed.

Given this background, the dBSwitch can address the following security concerns:

1) Restrict connections between machines, such as from a client to another client or from a server to another server. This may be enforced as follows:

a) Connect clients to a physical port or set of ports on the dBSwitch denoted by Pc.

b) Connect servers to a physical port or set of ports on the dBSwitch denoted by Ps.

c) Within the dBSwitch router, allow packets to be routed from Pc to Ps, but disallow or filter as needed, the passage of packets from Pc to Pc or from Ps to Ps.

2) Prevent unauthorized applicative access. This may be enforced as follows:

a) During setup of each application the dBSwitch may obtain the list of databases that the application uses.

b) During setup of each application the dBSwitch may obtain specification of clients that may execute the application. This specification may be in the form of an IP list or an expression that may be expanded to such a list. One type of expression that is typically used and may be evaluated very efficiently (to test if a particular client IP belongs to the list) is a mask, such as 192.*.*.*, denoting all machines within that subnet.

c) For each applicative access from a client to a database instance, the dBSwitch may check if there is an application that is authorized to access that database such that the client IP is a valid client for that application. If not, it may block the request, e.g. by instructing the router to drop the packet or to redirect it for the purpose of logging this connection attempt.

3) Prevent unauthorized administrative access.

The administrative security policies may be enforced as follows:

a) Each DSA function may have the following properties:

i) List of database instances managed by the DSA. Each such instance is associated with a unique virtual IP.

ii) List of other services that may be executed by the DSA. Those services may be tools related to database management offered by DBMS vendors, such as Oracle's Enterprise Manager (OEM), or by 3^{rd} parties such as Quest and Precise, among others. The services may also be general-purpose utilities such as FTP or TELNET. Each such service is associated with a specific, well known port.

iii) Specification of clients that the DSA may connect from, such as the IP of his workstation or IP mask of his subnet.

b) Only a DAA may add a new DSA or modify a DSA's properties. Additionally a DAA may function as DSA for any database instance.

c) The DSA may perform administrative access only to a database instance under his jurisdiction, in order to execute a service he/she is authorized for. Such access must specify the virtual IP of the database instance and the port of the requested service.

d) For each administrative access from a client to a database instance (virtual IP), the dBSwitch may check if there is a DSA that is authorized to access that database and execute the specified service, such that the client IP is a valid client for that DSA. If not, it may block the request, e.g. by instructing the router to drop the packet or to redirect it for the purpose of logging this connection attempt.

e) Each DAA function may have the following properties:

i) List of services that may be executed by the DAA. Each such service is associated with a specific, well known port.

ii) Specification of clients that the DAA may connect from, such as the IP of his workstation or IP mask of his subnet.

f) For each administrative access from a client to a database server (physical IP), the dBSwitch may check if there is a DAA that is authorized to access that server and execute the specified service, such that the client IP is a valid client for that DAA. If not, it may block the request, e.g. by instructing the router to drop the packet or to redirect it for the purpose of logging this connection attempt.

It should be noted that the above-mentioned security mechanisms and policies do not necessarily replace or make obsolete the security mechanisms and policies employed in the network, operating systems and DBMS, such as firewalls, authorization and encryption, but rather complement them to ensure a higher level of security in the DAN environment.

Scaling and Redundancy

Scaling of the DAN architecture, according to the present invention, is achieved by adding clients and/or database servers, in order to increase the system capacity (ability to handle more database operations per second). In addition, the system may be configured for increased fault tolerance (high availability) and load balancing by redirecting database instances from failed or busy servers to healthy or unloaded server.

The dBSwitch according to the present invention can be scalable and provide for redundancy of the dBSwitch itself, to prevent the dBSwitch from becoming a performance bottleneck in a highly loaded system, or a single point of failure in a highly available system.

An important function performed by the dBSwitch is routing database requests from clients to servers in real time. This function is performed by the dBSwitch router, based on a mapping of database instances to servers that is constructed by the dBSwitch software. This mapping does not change often (it may be expected to change every few hours, or at most, several times an hour). Furthermore computing this mapping such that it satisfies the resource management goals (i.e. load balancing, scalability and high availability) is not CPU intensive. In addition, any change to the mapping may be done by sending to the router a series of change instructions (e.g. routing table deletions and insertions), followed by a single instruction that causes the changes to take effect. Hence failure of the dBSwitch software does not result in discontinuation of the real time switching operation.

Scaling of the database switching functionality can be achieved by adding a second dBSwitch router (or more) and dividing the load between the routers. In one embodiment, where virtual service IP addresses are used, load balancing can be achieved by assigning the responsibility of routing the virtual IP addresses evenly between the routers. For example, if the virtual IP addresses are in the range 172.0.0.1 through 172.0.0.16, then the first router can be in charge of address range 172.0.0.1 through 172.0.0.8 and the second router can be in charge of address range 172.0.0.9 through 172.0.0.16. The division of virtual IP addresses between the routers can be adjusted dynamically according to the actual load, i.e. the demand for each service at a given point in time. Note that scaling of the present invention in this manner is transparent to both the database servers and clients.

Redundancy of the switching function can be achieved in a similar manner, by using more than one dBSwitch router. If the dBSwitch detects that a particular router fails, it may transfer its routing responsibilities to other routers, as described above. Alternatively, if it is desired that router failover be as fast as possible, then each primary router can be assigned a backup router that is idle and has an identical routing configuration in memory, which is kept synchronized with the primary configuration. Upon primary router failure, the backup router merely has to be started and can immediately assume routing responsibilities.

Advantages of the Present Invention:

Database Management Systems (DBMS) are well known. A large (e.g. Fortune 1000) organization may have dozens or even hundreds of different database applications, and in the typical market situation these applications are connected to a similar number of dedicated database servers. The complexity of management and the total cost of operation (TCO) of these databases including the hardware (database servers), software (DBMS licenses) and administration (DBA salaries) can therefore be very high.

The present invention provides a method and system for improving utilization and simplifying the management of a group of database servers in a shared and heterogeneous application environment.

The present invention provides a method and system which can be embodied in an appliance herein referred to as a Database Switch or dBSwitch. The dBSwitch can be situated between the applications and database servers in a network, capable of dynamically and transparently connecting applications to databases using virtually any database server and protocol.

The dBSwitch enables the formation of a Database Area Network (DAN) architecture, which promotes database virtualization by integrating the database servers, the shared storage, and the interconnecting network, making them appear to be one large, scalable database server.

This DAN architecture can provide high utilization, high availability, scalability on demand, simplified management and security, in a shared and heterogeneous application environment.

Current failover systems provide database scalability and dynamic failover by utilizing an extension of the operating system on the server machines (cluster software) or continuous replication of the DBMS contents between pre-designated nodes. Parallel DBMSs provide increased throughput (the number of database operations, transactions or queries completed in a given time span, such as a minute), scalability and dynamic failover, and are geared for a single, massive application that cannot run adequately on a single server. Systems according to the present invention, in contrast, provides database virtualization, enabling high utilization, high availability, scalability on demand and security for a heterogeneous set of applications, utilizing commonly available database servers and operating systems.

The present invention enables the processing of a plurality of database instances simultaneously on the same database server, while providing a virtualization of database services as if each service was running on a dedicated database server. This virtualization provides each database with quality of service, autonomy of administration, and security.

The dBSwitch appliance can be operated by software that does not keep track of the state of connections between the applications and the database servers, and any change in routing decisions made by this software can be applied incrementally, thus making communication between applications and said database servers immune to failure of the software.

The dBSwitch appliance can be easily extended to provide increased capacity (scalability) and redundancy (fault tolerance).

The present invention, when configured with a content switch (layers 5-7 switch), can comprehend messages exchanged between applications and database servers, enabling provisioning of enhanced application security and quality of service.

The architectural design of the present invention is novel, incorporating shared storage, a plurality of databases (DBMS), and the Database Switch appliance, such that there is a database virtualization system, managed by the Database Switch. The system, furthermore, may integrate Routing, Content Switching, Network Security, Applications, Databases, Clustering, Quality of Service and Network Management into a cohesive system, which is highly challenging in its design and implementation.

The method and system according to the present invention provide for the simultaneous execution of a plurality of instances of a single DBMS, such that each database service appears to be running on a dedicated database server.

The present invention enables stateless operation of the DBMS, such that any change in routing decisions made by the DBMS software is applied incrementally to the networking device, thus making communication between applications and database servers immune to failure of software.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A database area network (DAN) system comprising:
a plurality of database management systems adapted for providing access to database data;
a shared storage system, connected to said database management systems for storing said database data;
a database switching system adapted for directing the transfer of data packets between at least one database client and said database management systems.

2. The system of claim 1, wherein said database switching system includes a switching device adapted for switching or routing said data packets between said at least one database client and said database management systems.

3. The system of claim 1, wherein said database switching system is adapted for translating a network destination address of a database service request received from a database client to a network destination address of a database management system.

4. The system of claim 3, wherein said translated network destination address of a database service is a network layer addresses or data link layer addresses.

5. The system of claim 3, wherein said network destination address of a database service is translated from a virtual network address to an actual network destination address.

6. The system of claim 1, wherein said database switching system includes a routing or switching device adapted to provide data packet routing or switching functions and said routing or switching functions can be controlled using a command line interface procedure or a network management protocol.

7. The system of claim 1, wherein said database switching system includes a redirection module adapted for relocating a database instance from a first database server to a second database server.

8. The system of claim 1, wherein said database switching system includes a resource management module adapted for managing an association between database instances and database servers.

9. The system of claim 8, wherein said resource management module further includes a data storage device and is adapted for storing server resource information or database instance requirements in said data storage device.

10. The system of claim 9, wherein said resource management module is further adapted for managing the association between database instances and database servers as a function of the server resource information or the database instance requirements.

11. The system of claim 9, wherein said resource management module is adapted for storing constraints or preferences regarding database instance redirection in said data storage device.

12 The system of claim 11, wherein said resource management module is further adapted for managing the association between database instances and database servers as a function of said constraints or preferences regarding database instance redirection stored in said data storage device.

13. The system of claim 1, wherein said database switching system further includes a module adapted for relocating a database instance from a first database server to a second database server as a function of defined database performance criteria.

14. The system of claim 1, wherein said database switching system includes a database switching module adapted for associating database services with network addresses.

15. The system of claim 14, wherein said network addresses are virtual network addresses.

16. The system of claim 14, wherein said network addresses are network layer addresses or data link layer addresses.

17. The system of claim 14 wherein said database switching system is adapted for directing the transfer of data packets between said database clients and said database management systems as a function of the associations between said database services and said network addresses.

18. The system of claim 14, wherein said database switching system is adapted for directing the transfer of data packets between said database clients and said database management systems by replacing a network address of said data packet containing a service request with the network address associated with that service.

19. The system of claim 18, wherein the network address of said data packet containing a service request is a virtual network address and said virtual network address is replaced with a real network address associated with said service.

20. The system of claim 18, wherein the network address of said data packet containing a service request is for a network address on a first subnetwork and said network address is replaced with a network address associated with said database service on a second subnetwork.

21. The system of claim 14, wherein said database switching system includes a content switch adapted to read at least a portion of the contents of packets transferred between said at least on database client and said database management systems.

22. The system of claim 14, wherein said database switching system includes
a network device adapted for routing or switching data packets across said database area network, said network device including network management means for managing routing or switching functions of the network device and
said database switching module is adapted to use said network management means to control the routing or switching functions of the network device.

23. The system of claim 22, wherein said network device is adapted to provide real time routing of data packets across said database area network with low latency.

24. The system of claim 22, wherein said network device is adapted to provide real time routing of data packets across said database area network with high bandwidth.

25. The system of claim 22, wherein said database switching module is adapted for dynamically establishing said associations between database services and network addresses, and for automatically communicating the establishment or modification to said associations to said network device, whereby said database area network continues to function if said database switching module stops operating.

26. The system of claim 25, wherein said database switching module stops operating because of a failure of said database switching module or a connection between said database switching module and said network device.

27. The system of claim 25, wherein said database switching module stops operating because it is taken out of service for modification or upgrade.

28. The system of claim 14, wherein said database switching device is further adapted for dynamically associating database services with network addresses as a function of predefined resource management objectives.

29. The system of claim 28, wherein said resource management objectives are selected from the group consisting of load balancing, quality of service, high availability and scalability.

30. The system of claim 28, wherein said database services are executed on a plurality of database servers corresponding to said associated network addresses and said database switching module further includes:
monitoring means for monitoring a plurality database servers for server status and server resource usage;
mapping means for changing the associations between database services and network addresses as a function said server status and said server resource usage.

31. The system of claim 30, wherein said mapping means is adapted for changing the associations between database services and network addresses as a function of server resource usage and said management resource objective of load balancing in order to balance the server resource usage over a plurality of database servers.

32. The system of claim 30, wherein said mapping means is adapted for changing the associations between database services and network addresses as a function of server resource usage and said management resource objective of quality of service in order to make server resources available to provide a predefined level of quality of service.

33. The system of claim 32, wherein said predefined level of quality of service is measured as a function of allocated server resources.

34. The system of claim 32, wherein said predefined level of quality of service is measured as function of a quantity of database server operations processed in a specified unit of time.

35. The system of claim 32, wherein said predefined level of quality of service is measured as a function of a unit of time used to complete a database server operations or set of database server operations.

36. The system of claim 30, wherein said mapping means is adapted for changing the associations between database services and network addresses as a function of server resource usage and said management resource objective of high availability in order to provide that a database service is available from an alternative database server if said monitoring means detects that a database server providing said database service experiences a failure.

37. The system of claim 30, wherein said mapping means is adapted for changing the associations between database services and network addresses as a function of server resource usage and said management resource objective of scalability in order to distribute database resource usage over additional database resources added to the database area network.

38. The system of claim 1, wherein said database switching system includes a database area network administration module adapted for controlling administrative access to devices and services connected to the database area network.

39. The system of claim 38, wherein said database area network administration module provides a plurality of levels of access including a first level which provides access to all devices or services included in said database area network; and a second level of access which provides access to specific databases and their associated instances.

40. The system of claim 38, wherein said database area network administration module is adapted for controlling access by a first network device connected to said data area network to a second network device connected to said data area network.

41. A method for operating a database area network (DAN) comprising the steps of:
connecting a plurality of database servers to a communication medium, each database server including at least one database management system adapted for providing a plurality of database services;
associating at least one database service with at least one database server; and
directing the transfer of database service requests to an associated database server as a function of the association between at least one database service and at least one database server.

42. A method according to claim 41, wherein said step of directing the transfer of database service requests includes routing or switching data packets containing the database service requests between a database client and said database servers.

43. A method according to claim 41, wherein said step of directing the transfer of database service requests includes translating a network destination address of a database service request received from a database client to a network destination address of a database service.

44. A method according to claim 43, wherein said translated network destination address of a database service is a network layer address or data link layer address.

45. A method according to claim 43, wherein said network destination address of a database service is translated from a virtual network address to an actual network destination address.

46. A method according to claim 41, further including the step of relocating a database instance from a first database server to a second database server.

47. A method according to claim 41, further including the steps of:
storing server resource information or database instance requirements in a data storage device; and
said step of associating at least one database service with at least one database server includes associating a database service with a database server as a function of the server resource information or the database instance requirements stored in said data storage device

48. A method according to claim 41, further including the step of moving a database instance from a first database server to a second database server as a function of a defined database performance criteria.

49. A method according to claim 41, wherein the step of directing the transfer of database service requests includes directing the transfer of database service requests to a database server as a function of a portion of the content of a data packet containing said database service request.

50. A method according to claim 41 further comprising the step of transferring database service requests in real time with low latency between the database servers and database clients.

51. A method according to claim 41 further comprising the step of transferring database service requests in real time with high bandwidth between the database servers and database clients.

52. A method according to claim 41 further comprising the step of:
connecting a database switch (dBSwitch) to said communications medium and wherein said dBSwitch is adapted for associating at least one database service with at least one database server and directing the transfer of database service requests to said database servers as a function of the association between said database services and said at least one database server.

53. A method according to claim 52, wherein said dBSwitch includes a network device adapted to provide data packet routing or switching functions to said communications medium, and said routing or switching functions can be controlled using a command line interface procedure or a network management protocol; and said method further includes the step of controlling the routing or switching function of the routing or switching device using a command line interface procedure or a network management protocol.

54. A method according to claim 53, further comprising the step of modifying the switching or routing function of said switching or routing device as a function of said associations between the database services and said at least one database server.

55. A method according to claim 52, wherein said dBSwitch includes a database switching module and method includes the steps of:
said database switching module dynamically establishing associations between database services and database servers;
automatically communicating the establishment or modification to said associations to said network device, and,
continuing to transfer said database service requests to an associated database server even if said database switching module stops operating.

56. A method according to claim 55, wherein said database switching module stopped operating because of a failure in said database switching module.

57. A method according to claim 55, wherein said database switching module stopped operating because it was taken out of service for modification or upgrade.

58. A method according to claim 55, further comprising the step of said database switching module dynamically associating database services with network addresses as a function of predefined resource management objectives.

59. A method according to claim 58, wherein said resource management objectives are selected from the group consisting of load balancing, quality of service, high availability and scalability.

60. A method according to claim 58, wherein said database services are executed on a plurality of database servers corresponding to said associated network addresses and said method further includes the steps of
said database switching module monitoring a plurality of database servers for server status and resource usage; and
said database switching module changing the associations between database services and network addresses as a function of said server resource usage.

61. A method according to claim 60, wherein the step of changing the associations between database services and network addresses includes changing the associations between database services and network addresses as a function of server resource usage and said management resource objective of load balancing in order to balance the server resource usage over a plurality of database servers.

62. A method according to claim 60, wherein said step of changing the associations between database services and network addresses includes changing the associations between database services and network addresses as a function of server resource usage and said management resource objective of quality of service in order to make server resources available to provide a predefined level of quality of service.

63. A method according to claim 62, wherein said predefined level of quality of service is measured as a function of allocated server resources.

64. A method according to claim 62, wherein said predefined level of quality of service is measured as function of a quantity of database server operations processed in a specified unit of time.

65. A method according to claim 62, wherein said predefined level of quality of service is measured as a function of a unit of time used to complete a database server transaction or set of database server transactions.

66. A method according to claim 60, wherein said step of changing the associations between database services and network addresses includes changing the associations between database services and network addresses as a function of server resource usage and said management resource objective of high availability in order to provide that a database service is available from an alternative database server if said monitoring means detects that a database server providing said database service experiences a failure.

67. A method according to claim 60, wherein said step of changing the associations between database services and network addresses includes changing the associations between database services and network addresses as a function of server resource usage and said management resource objective of scalability in order to distribute database resource usage over additional database resources added to the database area network.

68. A method according to claim 41, wherein said database switching module includes a database area network administration module and said method includes the steps of said database area network administration module providing administrative access control to devices and services connected to the database area network.

69. A method according to claim 68, further comprising the step of:
said database area network administration module providing a plurality of levels of access including a first level which provides access to all devices or services included in connected to said database area network; and a second level of access which provides access to specific databases and their associated instances.

70. A method according to claim 68, further comprising the step of said database area network administration module controlling access by a first network device connected to said data area network to a second network device connected to said data area network.

71. An apparatus adapted for transferring data packets between at least one database server and at least one database user, said apparatus comprising:
connecting means for connecting at least one database client and at least one database server; and
switching means for directing the transfer of said data packets between a database user and at least one database server.

72. An apparatus according to claim 71 wherein said switching means includes a switching or routing device adapted for routing said data packets between said database client and at least one of said database management systems.

73. An apparatus according to claim 70 wherein
said directing means includes translation means for translating a network destination address of a database service request received from a database client to a network destination address of a database server.

74. An apparatus according to claim 73 wherein said translated network destination address of a database service is a network layer addresses or data link layer addresses.

75. An apparatus according to claim 73 wherein said network destination address of a database service is translated from a virtual network address to an actual network destination address.

76. An apparatus according to claim 71 further comprising a routing or switching device adapted to provide data packet routing or switching functions and said routing or switching functions can be controlled using a command line interface procedure or a network management protocol.

77. An apparatus according to claim 71 further comprising a redirection module adapted for relocating a database instance from a first database server to a second database server.

78. An apparatus according to claim 71 further comprising a resource management module adapted for managing database instance assignments to database servers.

79. An apparatus according to claim 78 wherein said resource management module further includes a data storage device and is adapted for storing server resource information or database instance requirements in said data storage device.

80. An apparatus according to claim 79 wherein said resource management module is further adapted for managing database instance assignments as a function of the server resource information or the database instance requirements.

81. An apparatus according to claim 79 wherein said resource management module is adapted for storing constraints or preferences regarding database instance redirection in said data storage device.

82. An apparatus according to claim 81 wherein said resource management module is further adapted for managing the association between database instances and database servers as a function of said constraints or preferences regarding database instance redirection stored in said data storage device.

83. An apparatus according to claim 71 further comprising a module adapted for moving a database instance from a first database server to a second database server as a function of a defined database performance criteria.

84. An apparatus according to claim 71 further comprising a database switching module adapted for associating database services with network addresses.

85. An apparatus according to claim 84 wherein said network address are virtual network addresses.

86. An apparatus according to claim 84 wherein said network address are network layer addresses or data link layer addresses.

87. An apparatus according to claim 84 wherein said switching means is adapted for directing the transfer of data packets between said database clients and said database servers as a function said associations between said database services and said network addresses.

88. An apparatus according to claim 84 wherein said switching means is adapted for directing the transfer of data packets between said database clients and said database management systems by replacing a network address of said data packet containing a database service request with the network address associated with that service.

89. An apparatus according to claim 88 wherein the network address of said data packet containing a service request is a virtual network address and said virtual network address is replaced with a real network address associated with said service.

90. An apparatus according to claim 88 wherein the network address of said data packet containing a service request is for a network address on a first subnetwork and said network address is replaced with a network address associated with said database service on a second subnetwork.

91. An apparatus according to claim 84 wherein said database switching system includes a content switch adapted to read at least a portion of the contents of packets transferred between said at least on database client and said database management systems.

92. An apparatus according to claim 84 further comprising
a network device adapted for routing or switching data packets across said database area network, said network device including network management means for managing routing or switching functions of the network device and
said database switching module is adapted to use said network management means to control the routing or switching functions of the network device.

93. An apparatus according to claim 92 wherein said network device provides real time routing of data packets across said database area network with low latency.

94. An apparatus according to claim 92 wherein said network device provides real time routing of data packets across said database area network with high bandwidth.

95. An apparatus according to claim 92 wherein said database switching module is adapted for dynamically establishing said associations between database services and network addresses, and for automatically communicating the establishment or modification to said associations to said network device, whereby said database area network continues to function if said database switching module stops operating.

96. An apparatus according to claim 95 wherein said database switching module stops operating because of a failure of said database switching module or a connecting between said database switching module and said network device.

97. An apparatus according to claim 95 wherein said database switching module stops operating because it is taken out of service for modification or upgrade.

98. An apparatus according to claim 84 wherein said database switching de vice is further adapted for dynamically associating database services with network addresses as a function of predefined resource management objectives.

99. An apparatus according to claim 98 wherein said resource management objectives are selected from the group consisting of load balancing, quality of service, high availability and scalability.

100. An apparatus according to claim 98 wherein said database services are executed on a plurality of database servers corresponding to said associated network addresses and said database switching module further includes:
monitoring means for monitoring a plurality database servers for server status and server resource usage;
mapping means for changing the associations between database services and network addresses as a function said server status and server resource usage.

101. An apparatus according to claim 100 wherein said mapping means is adapted for changing the associations between database services and network addresses as a function of server resource usage and said management resource objective of load balancing in order to balance the server resource usage over a plurality of database servers.

102. An apparatus according to claim 100 wherein said mapping means is adapted for changing the associations between database services and network addresses as a function of server resource usage and said management resource objective of quality of service in order to make server resources available to provide a predefined level of quality of service.

103. An apparatus according to claim 102 wherein said predefined level of quality of service is measured as a function of allocated of server resources.

104. An apparatus according to claim 102 wherein said predefined level of quality of service is measured as function of a quantity of database server operations processed in a specified unit of time.

105. An apparatus according to claim 102 wherein said predefined level of quality of service is measured as a function of a unit of time used to complete a database server operation or set of database server operations.

106. An apparatus according to claim 100 wherein said mapping means is adapted for changing the associations between database services and network addresses as a function of server resource usage and said management resource objective of high availability in order to provide that a database service is available from an alternative database server if said monitoring means detects that a database server providing said database service experiences a failure.

107. An apparatus according to claim 100 wherein said mapping means is adapted for changing the associations between database services and network addresses as a function of server resource usage and said management resource objective of scalability in order to distribute database resource usage over additional database resources added to the database area network.

108. An apparatus according to claim 71 wherein said database switching system includes a database area network administration module adapted for controlling administrative access to devices and services connected to the database area network.

109. An apparatus according to claim 108 wherein said database area network administration module provides a plurality of levels of access including a first level which provides access to all devices connected to said database area network; and a second level of access which provides access to specific databases and associated instances of said specific databases.

110. An apparatus according to claim 108 wherein said database area network administration module is adapted to control said database switching system to control database area network access to network devices or databases.

111. An apparatus according to claim 71 wherein said connecting means allows for connection of the apparatus between two data link layer switches, where one data link layer switch is connected to at least one database server, and the other data link layer switch is connected to at least one database client

112. An apparatus according to claim 71 wherein said connecting means allows for connection of the apparatus to a data link layer switch, where the data link layer switch is connected to at least one database server and at least one database client
